(19) United States
(12) Patent Application Publication
(10) Pub. No.: US 2003/0115066 A1
(43) Pub. Date: Jun. 19, 2003

(54) Method of using automated speech recognition (ASR) for web-based voice applications

(76) Inventors: Albert R. Seeley, Burlington, MA (US); Douglas Williams, Acton, MA (US); Zhongyi Chen, Burlington, MA (US); Robert Edmondson, Reading, MA (US)

Correspondence Address: DALY, CROWLEY & MOFFORD, LLP, SUITE 101, 275 TURNPIKE STREET, CANTON, MA, 02021-2310, US

(21) Appl. No.: 10/321,100

(22) Filed: Dec. 17, 2002

Related U.S. Application Data
(60) Provisional application No. 60/341,491, filed on Dec. 17, 2001.

(51) Int. Cl. G10L 21/00

(52) U.S. Cl. 704/270.1

(57) ABSTRACT

The present invention provides a method to automate the validation of dynamic data presented over telecommunications paths. The invention utilizes continuous speaker-independent speech recognition together with a process known generally as natural language recognition to reduce dynamic utterances to machine encoded text without requiring a prior training phase. Further, when configured by the end user to do so, the test system will convert common examples of dynamic speech, such as numbers, dates, times, and currency utterances into their usual textual representation.

### CROSS REFERENCE TO RELATED APPLICATIONS

This application claims priority under 35 U.S.C. § 119 (e) to provisional application serial No. 60/341,491 filed Dec. 17, 2001; the disclosure of which is hereby incorporated by reference.

### STATEMENT REGARDING FEDERALLY SPONSORED RESEARCH

Not Applicable.

### FIELD OF THE INVENTION

The present invention relates generally to voice application testing and more specifically to using automated speech recognition for web-based voice applications.

### BACKGROUND OF THE INVENTION

Automated data provider systems are used to provide data such as stock quotes and bank balances to users over phone lines. The information provided by these automated systems typically comprises two parts. The first part of the information is known as static data. This can be, for example, a standard greeting or prompt, which may be the same for a number of users. The second part of the information is known as dynamic data. For example, when providing a stock quote for a company the name of the company and the current stock price are dynamic data in the real world, because they change continuously as the users of the automated data provider systems make their selections and prices fluctuate.

In order to properly test such a system the automated data provider system needs to be tested at two levels. One level of testing is to test the static data provided by the automated data provider. This can be accomplished, for example, by testing the voice prompts that guide the user through the menus, ensuring that the correct prompts are presented in the correct order. A second level of testing is to test that the dynamic data reported to the user is correct, for example, that the reported stock price is actually the price for the named company at the time reported.

In existing test systems used to test automated data provider systems, speech data must be presented to the test system in a training phase prior to the testing phase, which prepares the system to recognize the same speech utterances when presented during the testing phase. The recognition scheme is generally known as discrete speaker dependent speech recognition. Thus, the system is limited to testing speech utterances presented to it a priori, and it is impractical to recognize dynamically changing utterances except where the set of all possible utterances is small.

One system that utilizes speech recognition as part of its provision of testing is the HAMMER IT™ test system available from Empirix Inc. of Waltham, Mass. The HAMMER IT test system recognizes the responses from the system under test and verifies that the received responses are the same responses expected from the system under test. This test system works extremely well for recognizing static responses and for recognizing a limited number of dynamic responses which are known by the test system, however the HAMMER IT test system currently cannot test for a wide variety of dynamic responses which are unknown by the test system.

Another test system is available from Interactive Quality Systems (IQS) of Hopkins, Minn., which utilizes an alternative recognition scheme, namely, length of utterance, but is still limited to recognizing utterances presented to it a priori.

A possible alternative would be a semi-automated system, in which the dynamic portion of the utterance would be recorded and presented to a human operator for encoding. The dynamic portion of the utterance would be recorded and presented to a human operator for encoding in machine-readable characters.

In view of the above, it would be desirable to have a test system that tests the responses of automated data provider systems which presents both static data and dynamic data. It would be further desirable to have a test system which does not need to know beforehand the possible dynamic data.

### SUMMARY OF THE INVENTION

The present invention provides a method to automate the validation of dynamic data (and static data) presented over telecommunications paths. The present invention utilizes continuous speaker-independent speech recognition together with a process known generally as natural language recognition to reduce dynamic utterances to machine encoded text without requiring a prior training phase. Further, when configured by the end user to do so, the test system will convert common examples of dynamic speech, such as numbers, dates, times, and currency utterances into their usual textual representation. For instance, the test system will convert the utterance “four hundred fifty four dollars and twenty nine cents” into the more usual representation of “454.29”. This will eliminate the limitation that all tested utterances need to be known by the test system in advance of the test.

By converting the dynamic utterances to machine encoded text, the invention facilitates automated validation of the data so converted, by allowing use of the converted data as input into an automated system which can independently access and validate the data.

Additionally, it is an object of the present invention to utilize Automated Speech Recognition (ASR) to perform several functions. These functions which utilize ASR include monitoring of Interactive Voice Response (IVR) applications, testing web-based voice applications, and using ASR in a hosted service environment. A command set is implemented to provide a programming interface between the testing/monitoring systems to the ASR functionality.

### BRIEF DESCRIPTION OF THE DRAWINGS

The invention will be better understood by reference to the following more detailed description and accompanying drawings in which:

FIG. 1 is a flow chart of the presently disclosed method.

### DETAILED DESCRIPTION

Proper testing of an automated data provider system requires the ability of the automated system performing the test to provide two functions. One function is the testing of static audio data received from the system under test. The audio data is received and processed and speech recognition is performed. The static portion of the utterance is validated against the expectations for the current state of the system under test. A second function of the test system is to provide a conversion from the verbal report of the data (dynamic data) by the system under test into a textual representation. The textual representation, typically in the form of machine encoded characters, is then used as an input into an automated system which can independently access the data in question and validate the accuracy of the response. For example, in the case of a stock quotation, accessing the stock exchange database and comparing the results of the access with the textual representation of the dynamic data verify the textual representation of the dynamic data.

One advantage of the present invention is that it directly reduces arbitrary dynamic utterances presented over telecommunications devices, such as dollar amounts, times, account numbers, and so on, into machine encoded character representations suitable for input into an automated independent validation system, without intermediate human intervention. Another advantage afforded by the present invention is that it eliminates the limitation imposed on known test systems that all possible tested utterances are known in advance of the test.

In the presently disclosed invention, the result of the testing of data from an automated data provider system will be one or more of the following three results. First, a text string of the recognized words, for example, “Enter|pin|number|”. Second, natural language “understanding” of the speech clip, so that, for example, “five hundred twelve dollars and thirty five cents” would be recognized as $512.35. Third a tag, which is a user defined name for a recognized utterance.

In addition, the presently disclosed system is able to perform speaker independent recognition, so that creating a vocabulary of static utterances is not necessary.

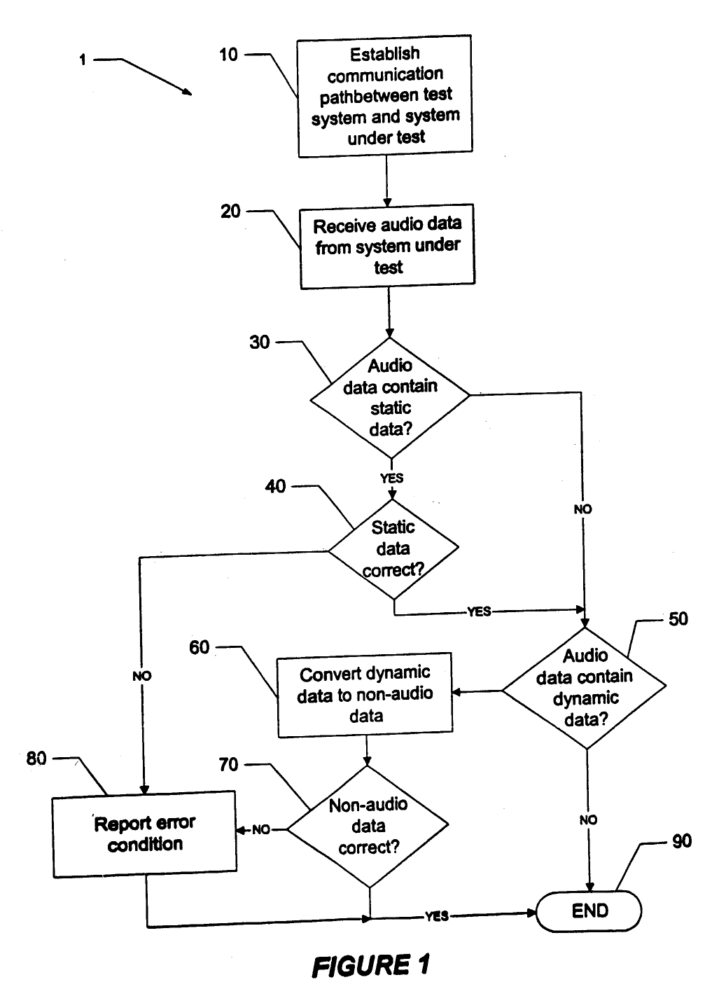

A flow chart of the presently disclosed method is depicted in FIG. 1. The rectangular elements are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

The first step 10 of the process is to establish a communications path between the test system and the system under test. This communications path may be a telephone connection, a wireless or cellular connection, a network or Internet connection or other types of connections as would be known by someone of reasonable skill in the art.

Step 20 comprises receiving audio data from the system under test by the test system through the communication path established in step 10. This received audio data may include static data, dynamic data or a combination of static and dynamic data. As an example, the list below contains the possible instances of audio data to be received from the system under test.

“This is the MegaMaximum bank”

“If you need assistance at any time, just say Help”

“Please enter or say your account number”

“Please enter or say your pin number”

“Your current balance is <dollars>”

“We're sorry, your account number or pin were not recognized. Please try again.”

“An associate will be with you shortly.”

Once the audio data is received, at step 30 a determination is made as to whether the audio data contains static data. In the case where the audio data comprises “This is the MegaMaximum bank”, the entire data is static data. In the case wherein the audio data received is “Your current balance is <dollars>” a combination of static data (“Your current balance is”) and dynamic data (“<dollars>”) has been received.

At step 40, a determination is made as to whether the static data is correct.

If the static data corresponds to the expected data the static data is deemed correct, then step 50 is executed. If the static data does not correspond to the expected data the static data is deemed incorrect, then an error condition is indicated as shown in step 90.

Following step 30 if no static data has been received, or step 40 if the static data received is correct, step 50 is executed. At step 50 a determination is made as to whether the received audio data contains dynamic data. If no dynamic data has been received, then step 80 is executed, and the process ends. If dynamic data has been received as part of the received audio data, then step 60 is executed.

Step 60 converts the dynamic data to non-audio data. This non-audio data can be, for example, a textual format such as machine encoded text. Other formats could also be used. Following the conversion of dynamic data to non-audio data, step 70 is executed.

Step 70 determines whether the non-audio data is correct. The non-audio data could be a stock price, a dollar amount, or the like. This non-audio data typically is compared to a database which contains the correct data. If the non-audio data was correct, then step 80 is executed and the process ends. If the non-audio data was not correct then step 90 is executed wherein an error condition is reported.

Referring back to the example dynamic data phrase “Your current balance is <dollars>” which contains the dynamic data, the user would construct a grammar to inform the recognizer of the expected utterances and their interpretation, so that, for example, the “<dollars>” slot would be interpreted as a monetary amount (“$512.00”) rather than a string of words (“five|hundred|twelve|dollars|and|zero|cents|”). The grammar could also assign tags (names) to each utterance, which the recognizer would return along with the text and/or interpretation. For the simpler applications, this would provide a solution conceptually similar to how prompt recognition is typically performed. The grammar would correspond to the vocabulary, and the tag would be a symbolic version of the clip number received as a recognition result.

Grammars are constructed as text files, with a GUI (Graphical User Interface) interface to ease the user through the arcane syntax. A pseudo-grammar might look as follows:

<phrase1> = (this is the megamaximum bank) {greeting}
<phrase2> = (if you need assistance just say help) {help_prompt}
<phrase3> = (please enter or say your account number) {account}
<phrase4> = (please enter or say your pin number) {pin}
<dollars> = [NUMBER]
<phrase5> = (your current balance is <dollars>{amount}){balance}
. . .

In the above examples, the elements inside the curly braces (“greeting”, “help_prompt”, “amount”, etc.) comprise the tags which are returned if their corresponding phrase were recognized.

When running the script, as each prompt is presented by the system under test, the prompt is sent off to be recognized, and a string, tag, and understanding, if any, are returned as the result. The script compares the returned string against the expected string, or simply checks the tag to see if it is the expected one. For the phrase “your current balance is <dollars>{amount}{balance}” above, the script compares only the first four words (static data—“your current balance is”), and compares the dollar amount (dynamic data—<dollars>) to the expected value as a separate operation.

To implement this, the following is required. A utility to enroll “MegaMaximum” into the speech recognizer's vocabulary. Another utility to set up a grammar. A command to connect the running script with the created grammar. Another command to compare strings and substrings on a word-by-word basis (rather than the character basis of most string utilities). A command to retrieve the “next slot” from the returned result, such as the <dollars> item from phrase number five. Another command to detect speech and “barge in” with the request for help. Another command to send the utterance to the new recognizer and obtain the result structure. In a particular embodiment the result structure would nominally include the status (recognized, failed), the tag (name) of the utterance, a probability score (0-100, with 100=best), and the text rendition of the utterance. If language understanding were performed, such as the translation of numeral names into currency, the recognized sub-portions would be included in the result structure as well.

As described above, the presently disclosed invention performs recognition on larger and more varied utterances than currently available systems. Further, the presently disclosed invention handles dynamic data seamlessly with static data.

One application involves the use of ASR for monitoring IVR applications. In this application test telephone calls are generated by a test system to an IVR and the speech responses are actively monitored. Prompts provided by the system under test are captured and analyzed for performance and accuracy.

One method utilized to transform human-readable text into speech is known as Text-To-Speech (TTS). TTS is often used in conjunction with Automated Speech Recognition (ASR) systems to render prompts with embedded dynamic speech elements. TTS may be used to convert either of a literal text string or text contained in a file.

Other applications involving the use of ASR are also provided. ASR is used to develop testing and monitoring solutions for web-based voice applications built on defined technologies. These technologies include standards for voice data such as Voice XML and Speech Application Language Tags (SALT). ASR may also be used as a core component of hosted services that provide both voice application load testing and voice application monitoring.

In a particular embodiment the programming interface to the ASR functionality from a test system comprises the following commands: AsrEnable Speech, AsrDisableSpeech, AsrRecognize, AsrRecognizeFile, AsrRecognizePartial, AsrGetResults, AsrGetAnswer, AsrGetSlot, AsrSetParameter, and AsrGet Parameter.

A method to automate the validation of dynamic data presented over telecommunications paths has been described. The invention utilizes continuous speaker-independent speech recognition together with a process known generally as natural language recognition to reduce dynamic utterances to machine encoded text without requiring a prior training phase. Further, when configured by the end user to do so, the test system will convert common examples of dynamic speech, such as numbers, dates, times, and currency utterances into their usual textual representation.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims. All publications and references cited herein are expressly incorporated herein by reference in their entirety.

We claim:

1. A method comprising:
establishing a communications path between a test system and a system under test (SUT);
receiving by said test system, audio data from said SUT;
determining whether said audio data contains static data, and when said audio data contains static data, verifying the correctness of said static data;
determining whether said audio data contains dynamic data, and when said audio data does contain dynamic data, converting said dynamic data to non-audio data and verifying the correctness of said non-audio data; and
reporting an error condition when at least one of said non-audio data and said static data is not correct.

2. The method of claim 1 wherein said non-audio data comprises text.

3. The method of claim 2 wherein said text comprises machine-encoded characters.

4. The method of claim 1 wherein said verifying the correctness of said non-audio data comprises independently acquiring data and comparing the independently acquired data to said non-audio data.

5. The method of claim 1 wherein said converting comprises utilizing natural language recognition.

6. The method of claim 1 wherein said converting includes converting common examples of dynamic data to their usual textual representation.

7. The method of claim 6 wherein said common examples of dynamic data includes numbers, dates, times and currency.

8. The method of claim 1 wherein said converting includes providing a tag for identifying said non-audio data.

9. A computer program product, disposed on a computer readable medium, the computer program product including instructions for causing a processor to:
establish a communications path between a test system and a system under test (SUT);
receive audio data from said SUT;
determine whether said audio data contains static data, and when said audio data contains static data, verify the correctness of said static data;
determine whether said audio data contains dynamic data, and when said audio data does contain dynamic data, convert said dynamic data to non-audio data and verify the correctness of said non-audio data; and
report an error condition when at least one of said non-audio data and said static data is not correct.

10. The computer program product of claim 9 wherein said non-audio data comprises text.

11. The computer program product of claim 10 wherein said text comprises machine-encoded characters.

12. The computer program product of claim 9 wherein said instructions for causing a processor to verify the correctness of said non-audio data comprises instructions for causing the processor to independently acquire data and compare the independently acquired data to said non-audio data.

13. The computer program product of claim 9 wherein said instructions for causing a processor to convert said dynamic data to non-audio data comprises utilizing natural language recognition.

14. The computer program product of claim 9 wherein said instructions for causing a processor to convert said dynamic data to non-audio data includes instructions for causing the processor to convert common examples of dynamic data to their usual textual representation.

15. The computer program product of claim 14 wherein said common examples of dynamic data includes numbers, dates, times and currency.

16. The computer program product of claim 9 wherein said instructions for causing a processor to convert said dynamic data to non-audio data includes instructions for causing the processor to provide a tag for identifying said non-audio data.
